(19) United States
(12) Patent Application Publication
(10) Pub. No.: US 2024/0310245 A1
(43) Pub. Date: Sep. 19, 2024

(54) DEVICE AND METHOD FOR DETERMINING AN ENVELOPE OF A SIGNAL

(71) Applicant: Aktiebolaget SKF, Göteborg (SE)

(72) Inventors: James P. LEBLANC, Luleå (SE); Patrik PÄÄJÄRVI, Södra Sunderbyn (SE)

(21) Appl. No.: 18/599,420

(22) Filed: Mar. 8, 2024

(30) Foreign Application Priority Data
Mar. 15, 2023 (DE) 102023202324.5

(51) Int. Cl. G01M 13/045

(52) U.S. Cl. CPC G01M 13/045

(57) ABSTRACT

A device (11) for determining an envelope of a signal (S9). The device includes a conditioning means (12), a first spectral analysis means (13), a filtering means (14), a second spectral analysis means (15), and determining means (16). The conditioning means (12) generates a vector of samples from samples of the signal (S9) at a first predetermined sampling rate. The first spectral analysis means (13) performs a spectral analysis of the vector of samples to obtain a set of frequency bins. The filtering means (14) filters the frequency bins to select a frequency bin having its frequency equal to at least one positive predetermined frequency. The second spectral analysis means (15) performs an inverse spectral analysis of the selected frequency bin to obtain an intermediary signal (S15). The determining means (16) determines the magnitude of the intermediary signal (S15).

### CROSS-REFERENCE TO RELATED APPLICATION

This application claims priority to German Application No. 102023202324.5, filed Mar. 15, 2023, the entirety of which is hereby incorporated by reference.

### FIELD

The present disclosure is directed to devices for determining an envelope of a signal and methods for determining an envelope of a signal.

### BACKGROUND

Generally, a bearing is provided with a vibration sensor delivering a signal representative of vibrations of the said bearing.

The envelope of the signal is determined and a spectral analysis is performed on the envelope using for example a fast Fourier analysis to get a spectrum.

Harmonics representative of defects of the bearing are identified from the spectrum, for example a defect on the raceway of the inner ring of the bearing.

Generally, to determine an envelope of the signal delivered by the vibration sensor, the signal is sampled and the samples of the signal are filtered by a band pass filter.

The band pass filter may comprise a cascade of inter dependent high and low order filters, for example Infinite Impulse Response filter IIR. Each filter requires to be carefully designed to limit phase response distortions limiting the filter magnitude responses.

The filtered signal output by the band pass filter is rectified by a signal rectifier. As the signal rectifier is non-linear, the sampling rate of the signal must be twice as the frequency of an envelope signal comprising the envelope of the signal. Such sample rate doubling has deleterious consequences for computation complexity and power consumption. Furthermore, the signal rectifier introduces spectral lines that are not present in the signal delivered by the vibration sensor.

The rectified signal is filtered by a low pass filter which removes the introduced frequency doubled components and acts as a smoothing filter. The low pass filter must be carefully design to limit phase distortions. Furthermore, the interplay with the band pass filter often leads to a fixed and non-optimal low pass filter parameterization.

The low pass filter outputs the envelope signal of the signal delivered by the vibration sensor.

To limit data transfer/storage of the enveloped signal, the envelope signal may be decimated by a decimation sub-system which lowers the signal sampling rate without introducing spectral aliasing. The decimation sub-system delivers a lower sample-rate representation of the envelope signal decimation of the envelope signal. The decimation sub-system has to be designed to limit distortions. Furthermore, the implementation of the decimation sub-system may increase the complexity of the determination of the output envelope signal and increase the power consumption

The designs of the bandpass filtering, rectification, low-pass filtering and decimation interact in such ways that limit parameter choices, and make difficult custom tuning.

Consequently, the present disclosure intends to simplify the determination of an envelope of a signal and reduce design constraints.

### SUMMARY

According to an aspect, a device for determining an envelope of a signal is proposed.

The device comprises:
conditioning means configured to generate a vector of samples from samples of the signal at a first predetermined sampling rate,
first spectral analysis means configured to perform a spectral analysis of the vector of samples to obtain a set of frequency bins, each frequency bin representing a magnitude and phase against a frequency value,
filtering means configured to filter the frequency bins to select a frequency bin having its frequency equal to at least one positive predetermined frequency, the frequency bin having its frequency equal to a predetermined frequency being a selected frequency bin,
second spectral analysis means configured to perform an inverse spectral analysis of the selected frequency bin to obtain an intermediary signal, the selected frequency bin being converted from the frequency domain to the time domain, and
determining means configured to determine the magnitude of the intermediary signal, the magnitude of the intermediary signal being equal to the envelope of the signal.

The filtering means perform spectral filtering without introducing phase distortions, because filtering may be a linear phase filtering.

Limited phase distortions are introduced in the envelope signal so that the envelope signal may be processed by algorithms implementing time-waveform based analysis methods such as time waveform peak-to-peak statistics.

Preferably, the conditioning means are configured to store the samples of the signal in the vector and to extend the vector with a number of zeros at most equal to the number of samples after the samples.

Advantageously, the filtering means are further configured to weight at least one selected frequency bin by a predetermined coefficient.

Preferably, the second spectral analysis means are further configured to sample the selected frequency bin at a second predetermined sample rate to generate modified selected frequency bin, the inverse spectral analysis being performed on the modified selected frequency bin.

Advantageously, the first spectral analysis means are configured to implement a fast Fourier transform algorithm, and the second spectral analysis means are configured to implement an inverse fast Fourier transform algorithm.

According to another aspect, a system for monitoring a bearing device, the bearing device comprising a bearing provided with an inner ring and with an outer ring capable of rotating concentrically relative to one another, and a vibration sensor measuring vibrations of the bearing is proposed.

The system comprises:
a device as defined above coupled to the vibration sensor,
third spectral analysis means configured to perform a spectral analysis of the envelope of the signal delivered by the vibration sensor, and
comparing means configured to compare the frequencies of the spectral analysis performed by the third spectral analysis means with fault signatures frequencies to identify a defect of the bearing.

Advantageously, the third spectral analysis means implement a fast Fourier transform algorithm.

According to another aspect, a bearing device is proposed.

The bearing device comprises:
a bearing provided with an inner ring and with an outer ring capable of rotating concentrically relative to one another,
a vibration sensor configured to measure the vibrations of the said inner or outer ring, and
a system as defined above coupled to the vibration sensor.

According to another aspect, a method for determining an envelope of a signal is proposed.

The method comprises:
generating a vector of samples from samples of the signal at a first predetermined sampling rate,
performing a first spectral analysis of the vector of samples to obtain a set of frequency bins, each frequency bin representing a magnitude and phase against a frequency value,
filtering the frequency bins to select a frequency bin having its frequency equal to at least one positive predetermined frequency, the frequency bin having its frequency equal to a predetermined frequency being a selected frequency bin,
performing an inverse spectral analysis of the selected frequency bin to obtain an intermediary signal, the selected frequency bin being converted from the frequency domain to the time domain,
determining the magnitude of the intermediary signal, the magnitude of the intermediary signal being equal to the envelope of the signal.

Advantageously, filtering the frequency bins further comprises weighting at least one selected frequency bin by a predetermined coefficient.

Preferably, the method further comprises sampling the selected frequency bin at a second predetermined sample rate to generate modified selected frequency bin, the inverse spectral analysis being performed on the modified selected frequency bin.

Advantageously, generating the vector of samples comprises storing the samples of the signal in the vector and extending the vector with a number of zeros at most equal to the number of samples after the samples.

Preferably, performing the first spectral analysis of the vector of samples comprises performing a fast Fourier transform of the vector of samples, and performing an inverse spectral analysis comprises performing an inverse fast Fourier transform of the selected frequency bins.

Advantageously, the bearing device comprising a bearing provided with an inner ring and with an outer ring capable of rotating concentrically relative to one another, and a vibration sensor measuring vibrations of the bearing, the method comprising the following steps:
determining an envelope of a signal delivered by the vibration sensor according to a method as defined above,
performing a second spectral analysis of the envelope of the signal delivered by the sensor, and
comparing the frequencies obtained from the second spectral analysis with fault signatures frequencies to identify a defect of the bearing.

### BRIEF DESCRIPTION OF THE DRAWINGS

Other advantages and features of the present disclosure will appear on examination of the detailed description of embodiments, in no way restrictive, and the appended drawings in which:

FIG. 1 illustrates schematically a rotating machine according to the present disclosure;

FIG. 2 illustrates schematically an example of a device for or monitoring a bearing device according to the present disclosure;

FIG. 3 illustrates an example of a method for determining the envelope of a signal according to the present disclosure;

FIG. 4 illustrates an example of set of frequency bins,

FIG. 5 illustrates an example of a spectral mask according to the present disclosure;

FIG. 6 illustrates schematically the result of the filtering of the set of frequency bins according to the present disclosure, and

FIG. 7 illustrates an example of a method for monitoring the bearing according to the present disclosure.

### DETAILED DESCRIPTION

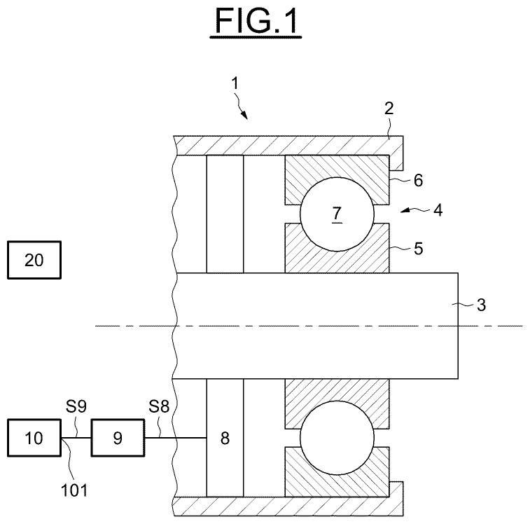

Reference is made to FIG. 1 which represents schematically a partial longitudinal cross section of a rotating machine 1.

The machine 1 comprises a housing 2 and a shaft 3 supported in the housing 2 by a rolling bearing 4 (e.g. roller bearing or ball bearing).

The rolling bearing 4 is provided with an inner ring 5 mounted on the shaft 3, and with an outer ring 6 mounted into the bore of the housing 2. The outer ring 6 radially surrounds the inner ring 5. The inner and outer rings 5, 6 rotate concentrically relative to one another.

The rolling bearing 4 is further provided with a row of rolling elements 7 radially interposed between inner and outer raceways of the inner and outer rings 5, 6. In the illustrated example, the rolling elements 7 are balls. Alternatively, the rolling bearing may comprise other types of rolling elements 7, for example rollers. In the illustrated example, the rolling bearing comprise one row of rolling elements 7. Alternatively, the rolling bearing comprise may comprise several rows of rolling elements.

A sensor 8 is mounted in the housing 2 to measure vibrations of the bearing 4 undergoing rotation.

The sensor 8 may be mounted on a bore of the housing 2.

In variant, the sensor 8 may be mounted elsewhere on the machine, near the outer ring 6 or in the vicinity of housing 2, for example.

The sensor 8 may deliver a continuous signal S8 representative of the vibrations of the bearing 4 to an input of a sampler 9.

The sampler 9 delivers a digital signal S9 comprising multiple sequential samples xₚ of the continuous signal S8 sampled at a fixed sample rate to an input 101 of a system 10 for monitoring a bearing device, p being an integer and may be superior or equal to 1.

The bearing 4, the sensor 8, the sampler 9 and the system 10 form a bearing device.

In another embodiment, the sensor 8 delivers the digital signal S9 comprising the multiple sequential samples xₚ, the bearing device comprising the bearing 4 and the sensor 8.

A memory (not represented) may store the output signal S9 and delivers the output signal S9 to the system 10.

A processing unit 20 implements the sensor 8, the sampler 9, and the system 10.

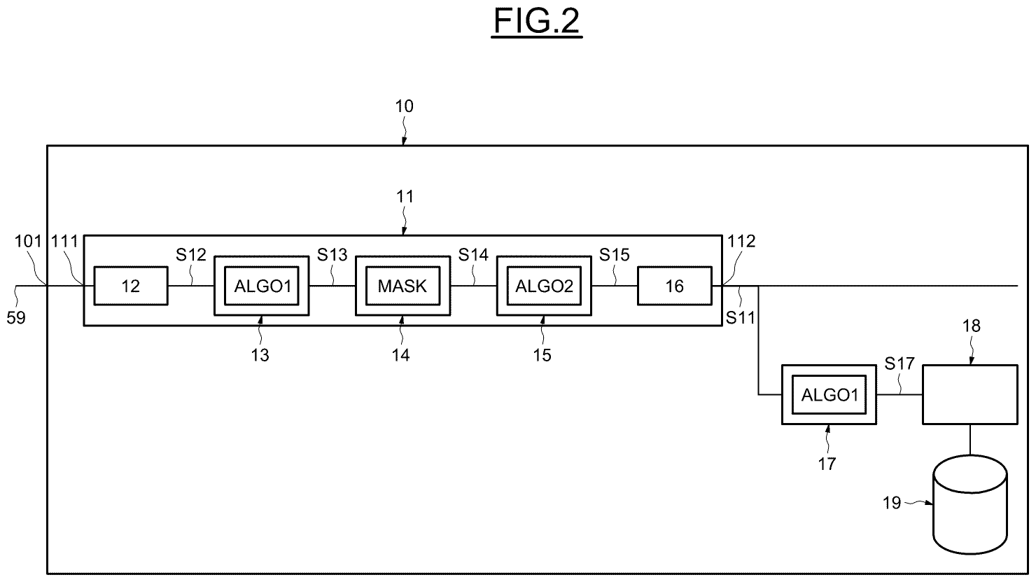

FIG. 2 illustrates schematically an example of the system 10.

The system 10 comprises a device 11 for determining an envelope of the output signal S9.

The device 11 comprises an input 111 connected to the input 101 of a system 10 and an output 112 delivering an envelope signal S11 comprising the envelope of the output signal S9.

The device 11 further comprises conditioning means 12 connected to the input 111 of the device 11 and delivering a signal S12 on an output of the device 11.

The device 11 comprises first spectral analysis means 13 connected to the conditioning means 12 and delivering a signal S13 on an output of the first analysis means 13.

The device 11 comprises filtering means 14 intended to filter the signal S13 delivered by the first spectral analysis means 13 and delivering a signal S14.

The device 11 comprises second spectral analysis means 15 connected to the filtering means 14 and delivering an intermediary signal S15 on an output of the second analysis means 15.

The device 11 comprises determining means 16 receiving the intermediary signal S15 delivered by the second spectral analysis means 15 and delivering an envelope signal S11 on the output 112 of the device 11.

The envelope signal S11 comprises the envelope of the signal S9 delivered by the sensor 8.

The system 10 may further comprises third spectral analysis means 17 connected to the output 112 of the device 11 and delivering a signal S17, comparing means 18, and a memory 10 storing fault signatures frequencies.

Each defect of the bearing 4 is associated to a fault signatures frequency.

The comparing means 19 comprising a first input connected to the third spectral analysis means 17 to receive the signal S17, and a second input connected to the memory 19.

The first spectral analysis means 13 and the third spectral analysis means 17 comprise a spectral analysis algorithm ALGO1, for example a fast Fourier transform.

The second spectral analysis means 15 comprises an inverse spectral analysis ALGO2, for example an inverse fast Fourier transform algorithm.

The filtering means 14 comprise a spectral mask MASK detailed in the following.

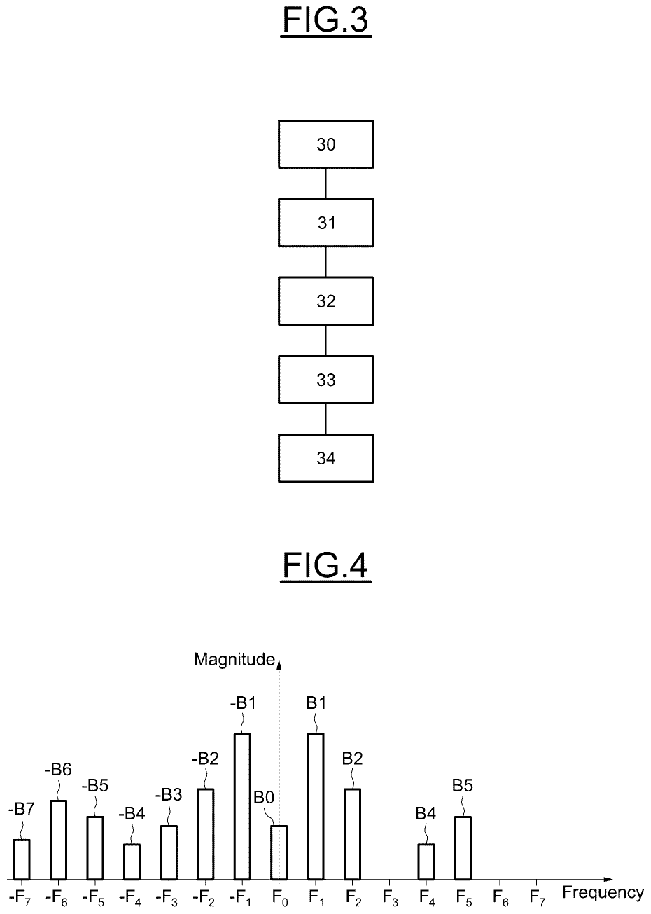

FIG. 3 illustrates an example of a method for determining the envelope S11 implemented by the device 11.

The output signal S9 comprises multiple sequential samples xₚ.

During a step 30, the conditioning means 20 generate a vector V of samples from the samples xₚ of the output signal S9.

The conditioning means 12 store the samples xₚ of the output signal S9 in the vector V and extends the vector V with same number of zeros at most equal to the number p of samples after the samples xₚ.

The vector V has p samples followed by p zeros so that:

$$V = [ {x}_{1} , {x}_{2} … {x}_{p} , 0 , 0 … 0 ] \qquad ( 1 )$$

During a step 31, the first spectral analysis means 13 perform a first spectral analysis of the vector V of samples to obtain a set of frequency bins, each frequency bin representing a magnitude and phase against a frequency value.

For clarity reasons, it is assumed that set of frequency bins comprises fifteen frequency bins.

The frequency set comprises seven negative frequency bins −B7, −B6, −B5, −B4, −B3, −B2, −B1, and eight non-negative frequency bins B0, B1, B2, B3, B4, B5, B6, B7 associated respectively to the negative frequencies −F₇, −F₆, −F₅, −F₄, −F₃, −F₂, −F₁, and non-negative frequencies F₀, F₁, F₂, F₃, F₄, F₅, F₆, F₇.

FIG. 4 illustrates an example of the set of frequency bins −B7, −B6, −B5, B4, −B3, −B2, −B1, B0, B1, B2, B3, B4, B5, B6, B7.

During a step 32 (FIG. 3), the filtering means 14 implementing the spectral mask MASK select a frequency bin having its frequency equal to at least one positive predetermined frequency.

The frequency bin having its frequency equal to the positive predetermined frequency is a selected frequency bin.

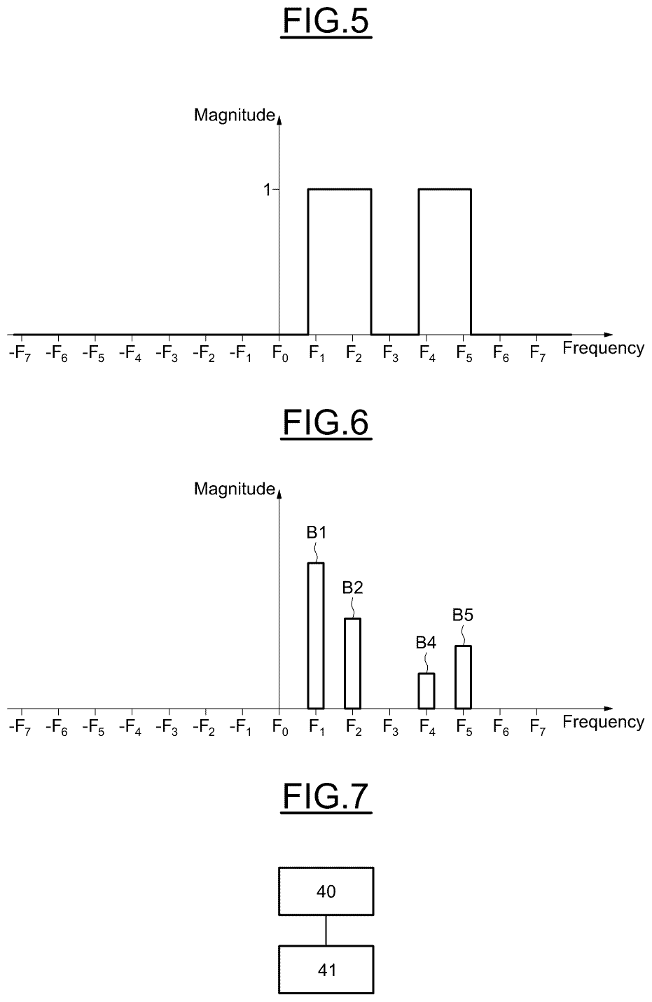

FIG. 5 illustrates an example of the spectral mask MASK.

The magnitude of the mask value associated to the predetermine frequency is set to a unitary value, for example “1” so that the magnitude of each selected frequency bin is equal to the magnitude of the frequency bin having its frequency equal to the positive predetermined frequency.

In variant, the magnitude of the mask value associated to at least the predetermine frequency is set to the unitary value multiplied by a predetermined coefficient between nil and the unitary value, for example between “0” and “1”, so that the selected frequency bin associated to the predetermined frequency is weighted.

The spectral mask MASK is a weighted spectral mask.

The selected frequency bin associated to the predetermined frequency may be weighted with a complex numerical value.

The magnitude associated to the negative frequencies are set to a logic low value, for example “0”, and the magnitude of the positive frequencies which are not selected are also set to “0”.

The mask MASK comprises the same frequencies as the frequencies of the set of frequency bins −B7, −B6, −B5, −B4, −B3, −B2, −B1, B0, B1, B2, B3, B4, B5, B6, B7

In this example, the frequencies F₁, F₂, F₄, F₅, are set to “1” so that the filtering means 14 select the frequency bins B1, B2, B4, B5 associated to the frequencies F₁, F₂, F₄, F₅.

Of course, the mask MASK may be parametrized to select more or less than four frequencies.

For example, the mask MASK may be configured as a low pass spectral filter, high pass spectral filter or band pass spectral filter, notch filter, or a combination of them.

FIG. 6 illustrates the result of the filtering of the set of frequency bins −B7, −B6, −B5, B4, −B3, −B2, −B1, B0, B1, B2, B3, B4, B5, B6, B7.

The magnitude of the positive frequency bins B1, B2, B4, B5, associated to the frequencies F₁, F₂, F₄, F₅ are kept, whereas the magnitude of the other frequency bins −B7, −B6, −B5, B4, −B3, −B2, −B1, B0, B3, B6, B7 is nil.

During the step 32 (FIG. 3), the filtering means 14 deliver the signal S14 comprising the selected frequency bins B1, B2, B4, B5.

During a step 33, the second spectral analysis means 15 perform the inverse spectral analysis of the selected frequency bins B1, B2, B4, B5 to obtain the intermediary signal S15, and deliver the intermediary signal S15.

The selected frequency bins are converted from the frequency domain to the time domain.

In variant, the second spectral analysis means 15 may sample the selected frequency bins B1, B2, B4, B5 at a second predetermined sample rate to generate modified selected frequency bins.

The inverse spectral analysis is performed on the modified selected frequency bins.

To sample the selected frequency bins B1, B2, B4, B5, the second spectral analysis means 15 select a restricted subsets of the selected frequency bins B1, B2, B4, B5.

The restricted subsets are at most equal to the selected frequency bins B1, B2, B4, B5.

During a step 34, the determining means 16 determine the envelope of the intermediary signal S15.

The envelope of the intermediary signal S15 is equal to the envelope components of the output signal S9. The determining means 16 deliver the envelope signal S11 is equal to the magnitude of the intermediary signal S15.

When the number of zeros is equal to the number p of samples, the error on the envelope signal S11 is the lowest.

The more the number of zeros in the vector V is great, the lower is the error on the envelope signal S11.

FIG. 7 illustrates an example of a method for monitoring the bearing 4.

It is assumed that determining means 16 deliver the envelope signal S15.

In a step 40, the third spectral analysis means 17 perform a second spectral analysis of the envelope signal S15.

In a step 41, the comparing means 18 compare the frequencies obtained from the second spectral analysis with fault signatures frequencies to identify a defect of the bearing 4.

The filtering means 14 may perform spectral filtering without introducing phase distortions, the filtering being linear phase.

Phase distortions may be limited in the envelope signal S11 so that the envelope signal S11 may be process by algorithms implementing time-waveform based analysis methods such as peak-to-peak.

The filtering means 14 replace the band pass filter known from the prior art allowing greater freedom of bandpass filtering.

Specification of several pass band, and notch suppression (for interference mitigation) is achieved simply by setting either the magnitude of a frequency to a “1”, or a “0” in the spectral mask MASK or values in between in the case of the spectral mask MASK being a weighted spectral mask.

This allows to easily design the filtering means 14 to the application of the machine 1 or to easily cancel frequencies associated to suspected interference environments.

Furthermore, as the filtering means 14 send only the positive bins associated to the selected frequency(ies), the second spectral analysis means 15 are designed to process the said positive bins limiting the process capability of the second spectral analysis means 15.

The filtering means 14 and the second spectral analysis means 15 implement the decimation function known from the prior art, the number of selected frequencies determines the decimation factor.

The device 11 does not comprise a signal rectifier known from the prior art so that the sampling frequency does not need to be doubled and no low pass filter known from the prior art is needed to remove introduced frequency doubled components produced by the signal rectifier.

The enveloping produced by the device 11 is low-pass in nature.

What is claimed is:

1. A device for determining an envelope of a signal, the device comprising:
conditioning means configured to generate a vector of samples from samples of the signal at a first predetermined sampling rate,
first spectral analysis means configured to perform a spectral analysis of the vector of samples to obtain a set of frequency bins, each frequency bin representing a magnitude and phase against a frequency value,
filtering means configured to filter the frequency bins to select a frequency bin having its frequency equal to at least one positive predetermined frequency, the frequency bin having its frequency equal to a predetermined frequency being a selected frequency bin,
second spectral analysis means configured to perform an inverse spectral analysis of the selected frequency bin to obtain an intermediary signal, the selected frequency bin being converted from the frequency domain to the time domain, and
determining means configured to determine the magnitude of the intermediary signal, the magnitude of the intermediary signal being equal to the envelope of the signal.

2. The device according to claim 1, wherein the conditioning means are configured to store the samples of the signal in the vector and extend the vector with a number of zeros at most equal to the number of samples after the sample.

3. A system for monitoring a bearing device, the bearing device comprising a bearing provided with an inner ring and with an outer ring capable of rotating concentrically relative to one another, and a vibration sensor measuring vibrations of the bearing, the system comprising:
a device according to claim 1 coupled to the vibration sensor,
third spectral analysis means configured to perform a spectral analysis of the envelope of the signal delivered by the vibration sensor, and
comparing means configured to compare the frequencies of the spectral analysis performed by the third spectral analysis means with fault signatures frequencies to identify a defect of the bearing.

4. A system for monitoring a bearing device, the bearing device comprising a bearing provided with an inner ring and with an outer ring capable of rotating concentrically relative to one another, and a vibration sensor measuring vibrations of the bearing, the system comprising:
a device according to claim 3 coupled to the vibration sensor,
third spectral analysis means configured to perform a spectral analysis of the envelope of the signal delivered by the vibration sensor, and
comparing means configured to compare the frequencies of the spectral analysis performed by the third spectral analysis means with fault signatures frequencies to identify a defect of the bearing.

5. A bearing device comprising:
a bearing provided with an inner ring and with an outer ring capable of rotating concentrically relative to one another,
a vibration sensor configured to measure the vibrations of the said inner or outer ring, and
a system according to claim 3 coupled to the vibration sensor.

6. A bearing device comprising:
a bearing provided with an inner ring and with an outer ring capable of rotating concentrically relative to one another,
a vibration sensor configured to measure the vibrations of the said inner or outer ring, and
a system according to claim 4 coupled to the vibration sensor.

7. A method for determining an envelope of a signal, the method comprising:
generating a vector of samples from samples of the signal at a first predetermined sampling rate,
performing a first spectral analysis of the vector of samples to obtain a set of frequency bins, each frequency bin representing a magnitude and phase against a frequency value,
filtering the frequency bins to select a frequency bin having its frequency equal to at least one positive predetermined frequency, the frequency bin having its frequency equal to a predetermined frequency being a selected frequency bin,
performing an inverse spectral analysis of the selected frequency bin to obtain an intermediary signal, the selected frequency bin being converted from the frequency domain to the time domain,
determining the magnitude of the intermediary signal, the magnitude of the intermediary signal being equal to the envelope of the signal.

8. The method according to claim 7, wherein filtering the frequency bins further comprises weighting at least one selected frequency bin by a predetermined coefficient.

9. The method according to claim 7, further comprising sampling the selected frequency bin at a second predetermined sample rate to generate modified selected frequency bin, the inverse spectral analysis being performed on the modified selected frequency bin.

10. The method according to claim 7, wherein generating the vector of samples comprises storing the samples of the signal in the vector and extending the vector with a number of zeros equal at most to the number of samples after the samples.

11. The method according to claim 7, wherein performing the first spectral analysis of the vector of samples comprises performing a fast Fourier transform of the vector of samples, and performing an inverse spectral analysis comprises performing an inverse fast Fourier transform of the selected frequency bins.

12. A method for monitoring a bearing device, the bearing device comprising a bearing provided with an inner ring and with an outer ring capable of rotating concentrically relative to one another, and a vibration sensor measuring vibrations of the bearing, the method comprising the following steps:
determining an envelope of a signal delivered by the vibration sensor according to a method according to claim 7,
performing a second spectral analysis of the envelope of the signal delivered by the sensor, and
comparing the frequencies obtained from the second spectral analysis with fault signatures frequencies to identify a defect of the bearing.

13. The method according to claim 8, further comprising sampling the selected frequency bin at a second predetermined sample rate to generate modified selected frequency bin, the inverse spectral analysis being performed on the modified selected frequency bin.

14. The method according to claim 13, wherein generating the vector of samples comprises storing the samples of the signal in the vector and extending the vector with a number of zeros equal at most to the number of samples after the samples.

15. The method according to claim 14, wherein performing the first spectral analysis of the vector of samples comprises performing a fast Fourier transform of the vector of samples, and performing an inverse spectral analysis comprises performing an inverse fast Fourier transform of the selected frequency bins.

16. A method for monitoring a bearing device, the bearing device comprising a bearing provided with an inner ring and with an outer ring capable of rotating concentrically relative to one another, and a vibration sensor measuring vibrations of the bearing, the method comprising the following steps:
determining an envelope of a signal delivered by the vibration sensor according to a method according to claim 15,
performing a second spectral analysis of the envelope of the signal delivered by the sensor, and
comparing the frequencies obtained from the second spectral analysis with fault signatures frequencies to identify a defect of the bearing.
